(19) United States
(12) Patent Application Publication
(10) Pub. No.: US 2024/0397422 A1
(43) Pub. Date: Nov. 28, 2024

(54) METHODS AND APPARATUS FOR RRM MEASUREMENT AND PAGING RELIABILITY USING LOW POWER WAKE-UP RECEIVER FOR WIRELESS SYSTEMS

(71) Applicant: INTERDIGITAL PATENT HOLDINGS, INC., Wilmington, DE (US)

(72) Inventors: Brian Martin, Farnham (GB); Virgil Comsa, Montreal (CA); Erdem Bala, East Meadow, NY (US); Moon IL Lee, Melville, NY (US); Paul Marinier, Brossard (CA); Janet Stern-Berkowitz, Little Neck, NY (US); Keiichi Kubota, Setagaya-Ku (JP)

(73) Assignee: INTERDIGITAL PATENT HOLDINGS, INC., Wilmington, DE (US)

(21) Appl. No.: 18/695,610

(22) PCT Filed: Sep. 27, 2022
(86) PCT No.: PCT/US2022/044796

§ 371 Date: Mar. 26, 2024

Related U.S. Application Data
(60) Provisional application No. 63/250,540, filed on Sep. 30, 2021.

(51) Int. Cl. H04W 52/02; H04L 5/00

(52) U.S. Cl. CPC H04W 52/0216; H04L 5/0044; H04L 5/0091; H04W 52/0225; H04W 52/0235

(57) ABSTRACT

A method may be implemented by a wireless transmit/receive unit (WTRU). The method may comprise receiving configuration information. The configuration information may comprise information regarding a first discontinuous reception (DRX) cycle with a first periodicity and a second DRX cycle with a second periodicity. The configuration information may comprise a time offset value (T). The configuration information may comprise a threshold value for wake-up signal (WUS) detection. The configuration information may comprise a number (N) of monitoring occasions for missed WUS detections. The method may comprise monitoring for a WUS according to the first periodicity. The method may comprise monitoring for a paging indication according to the second periodicity. The method may comprise monitoring, on a condition that a WUS is not detected. for the paging indication according to the first periodicity. and receiving the paging indication. The method may comprise transmitting data over a physical random access channel (PRACH).

### CROSS-REFERENCE TO RELATED APPLICATIONS

This application claims the benefit of U.S. Provisional Application No. 63/250,540, filed Sep. 30, 2021, the contents of which are incorporated herein by reference.

### BACKGROUND

Discontinuous reception (DRX) may be used for battery savings. During DRX, a wireless transmit/receive unit (WTRU) may not monitor a downlink (DL) control channel, for example a physical downlink control channel (PDCCH). In radio resource control (RRC) connected mode, a WTRU may use connected mode DRX (C-DRX). A WTRU may monitor a configured PDCCH during an ON duration period and the WTRU may sleep (e.g., not monitor a PDCCH) during an OFF duration period.

### SUMMARY

A method may be implemented by a wireless transmit/receive unit (WTRU). The method may comprise receiving configuration information. The configuration information may comprise information regarding a first discontinuous reception (DRX) cycle with a first periodicity and a second DRX cycle with a second periodicity. The configuration information may comprise a time offset value (T). The configuration information may comprise a threshold value for wake-up signal (WUS) detection. The configuration information may comprise a number (N) of monitoring occasions for missed WUS detections. The method may comprise monitoring for a WUS according to the first periodicity. The method may comprise monitoring for a paging indication according to the second periodicity. The method may comprise monitoring, on a condition that a WUS is not detected, for the paging indication according to the first periodicity, and receiving the paging indication. The method may comprise transmitting data over a physical random access channel (PRACH). The method may comprise determining that the WUS is not detected by determining that a measurement of the WUS is less than the threshold value for WUS detection for N consecutive monitoring occasions. The method may comprise monitoring for the paging indication according to the first periodicity after the time offset value (T) from a time of the Nth monitoring occasion. The second periodicity may be longer than the first periodicity. The WUS signal may be a low power WUS. The method may comprise monitoring for the WUS using a low power wake-up receiver (WUR). The WUS may have a first waveform type. The first waveform type may be non-orthogonal frequency division multiplexing (non-OFDM). The paging indication may be received via a second waveform type. The second waveform type may be orthogonal frequency division multiplexing (OFDM). The WTRU may monitor for the paging indication using a main transceiver. The paging indication may be received in a downlink control information (DCI) over a physical downlink control channel (PDCCH).

A wireless transmit/receive unit (WTRU) may comprise a low power wake-up receiver (WUR) and a main transceiver. The main transceiver may be configured to receive configuration information. The configuration information may comprise information regarding a first discontinuous reception (DRX) cycle with a first periodicity and a second DRX cycle with a second periodicity. The configuration may information comprise a time offset value (T). The configuration information may comprise a threshold value for wake-up signal (WUS) detection. The configuration information may comprise a number (N) of monitoring occasions for missed WUS detections. The WUR may be configured to monitor for a WUS according to the first periodicity. The main transceiver may be further configured to monitor for a paging indication according to the second periodicity. The main transceiver may be further configured to, on a condition that a WUS is not detected, monitor for the paging indication according to the first periodicity, and receive the paging indication. The main transceiver may be further configured to transmit data over a physical random access channel (PRACH). A processor may be configured to determine that the WUS is not detected by determining that a measurement of the WUS is less than the threshold value for WUS detection for N consecutive monitoring occasions. The main transceiver may be further configured to monitor for the paging indication according to the first periodicity after the time offset value (T) from a time of the Nth monitoring occasion. The second periodicity may be longer than the first periodicity. The WUS signal may be a low power WUS. The WUS may have a first waveform type. The first waveform type may be non-orthogonal frequency division multiplexing (non-OFDM). The paging indication may be received via a second waveform type. The second waveform type may be orthogonal frequency division multiplexing (OFDM). The paging indication may be received in a downlink control information (DCI) over a physical downlink control channel (PDCCH). The main transceiver may be further configured to perform radio resource management measurements. The main transceiver may be configured to be in a sleep mode when the WUR is monitoring for the WUS.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example of connected mode DRX;

FIG. 3 is an example of a connected mode wake-up signal (WUS);

FIG. 4 is an example of an idle mode wake-up signal (WUS);

FIG. 5 shows an example of a simplified architecture utilizing a low-power wake-up receiver (WUR);

FIG. 6 shows an example of dual DRX;

FIG. 7 shows an example of fallback DRX;

FIG. 8 shows an example method for DRX using a low power wake up signal;

FIG. 9 shows an example method for DRX using a low power wake up signal;

FIG. 10 shows an example method for DRX using a low power wake up signal

FIG. 11 shows an example method for DRX using a low power wake up signal

FIG. 12 shows an example method of rapid synch;

FIG. 13 shows an example method of wake-up signal (WUS) configuration; and

FIG. 14 shows an example method for determining a coverage state.

### DETAILED DESCRIPTION

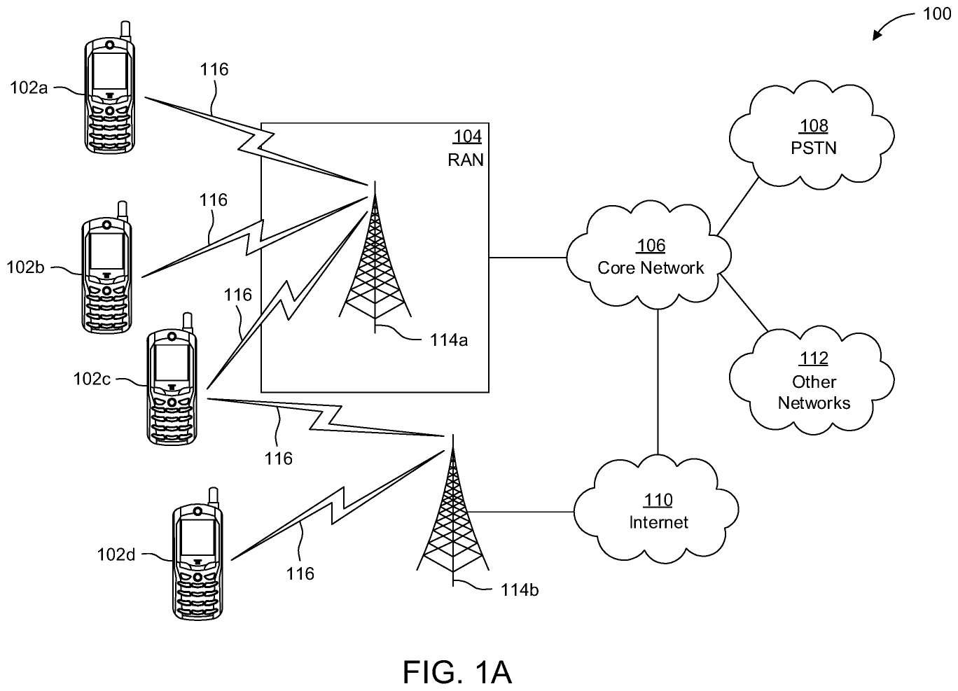

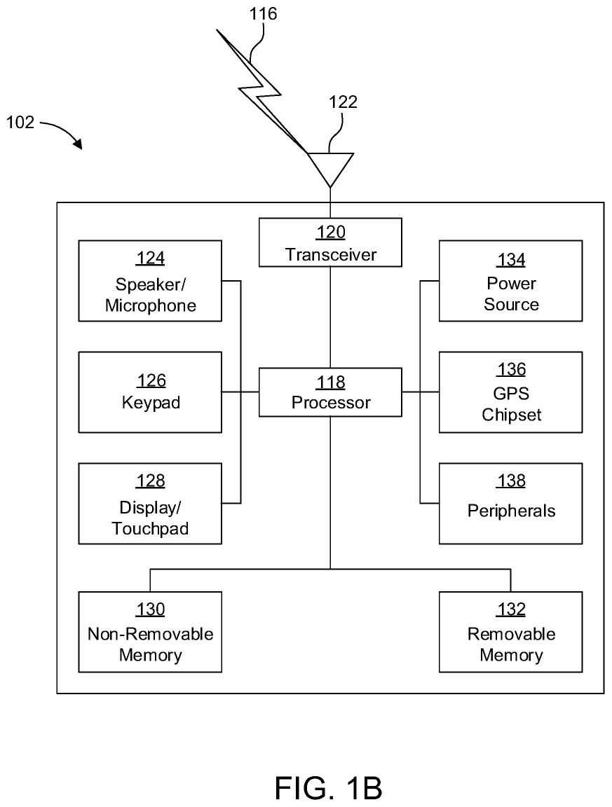

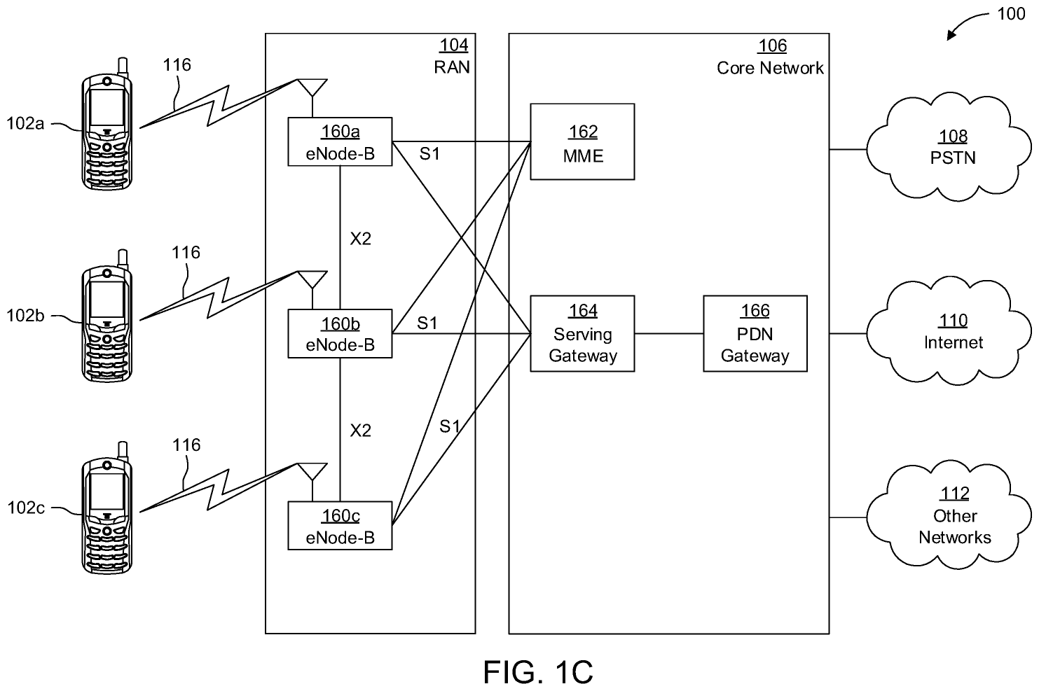

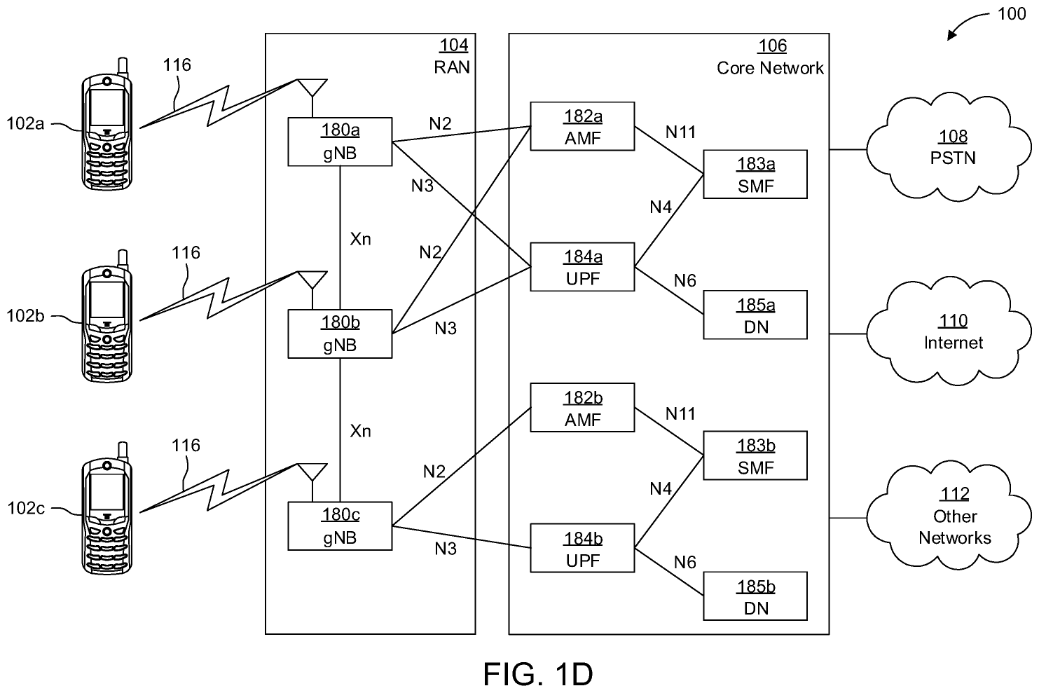

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non- standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

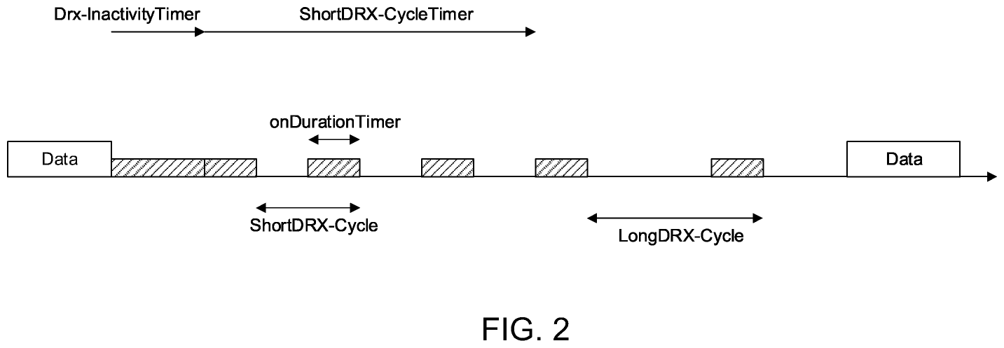

An example of connected mode DRX is shown in FIG. 2. A WTRU may be in connected mode DRX and may be applicable to LTE and/or 5G NR. A PDCCH may be used herein as a non-limiting example of a control channel.

A DRX cycle may be a cycle (e.g., a repetition or periodic repetition) of an ON duration and an OFF duration. A WTRU may monitor a PDCCH during an ON duration and a WTRU may skip monitoring a (e.g., any) PDCCH during an OFF duration. A DRX cycle may be a short DRX cycle or a long DRX cycle. A WTRU may use a short DRX cycle for a period of time and then may use a long DRX cycle for another period of time.

A timer (e.g. DRX inactivity timer) may determine or may be used to determine a time, (e.g., in terms of slot duration), after a PDCCH occasion in which a PDCCH (e.g., a successfully decoded PDCCH) indicates an (e.g., an initial) uplink (UL) or downlink (DL) user data transmission. The DRX inactivity timer may be used to determine when to go to an OFF duration. A DRX ON duration may be a duration at the beginning of a DRX cycle. An ON duration timer may determine or may be used to determine a number of (e.g., a consecutive number of) PDCCH occasion(s) that may be or may need to be monitored or decoded (e.g., by a WTRU), for example after wakeup from a DRX cycle or at the beginning of a DRX cycle.

A PDCCH occasion may be a time period that may contain a PDCCH such as a symbol, a set of symbols, a slot, or a subframe.

A timer (e.g. DRX retransmission timer) may determine or may be used to determine a number (e.g., a consecutive number) of PDCCH occasion(s) to monitor when a retransmission may be expected by the WTRU. A DRX retransmission timer may determine or may be used to determine a maximum duration until a DL retransmission may be received or a maximum duration until a grant for UL retransmission may be received.

A DRX short cycle (short-DRX-Cycle) may be a first DRX cycle that the WTRU enters or uses after expiration of a DRX inactivity timer. A WTRU may be in a short DRX cycle until an expiration of a DRX short cycle timer (e.g. short-DRX-CycleTimer). When the DRX short cycle timer expires, the WTRU may use a long DRX cycle (longDRX-cycle). A DRX short cycle timer may determine or may be used to determines a number of consecutive subframe(s) that the WTRU may follow a short DRX cycle after a DRX inactivity timer has expired.

A WTRU may or may need to monitor a PDCCH or PDCCH occasions during an Active Time. Active Time may occur during an ON duration. Active Time may occur during an OFF duration. Active Time may begin during an ON duration and continue during an OFF duration. Active Time and Active time of a DRX cycle may be used interchangeably herein.

Active Time may include the time while at least one (e.g., any one) of the following is true: a DRX timer may be running such as an ON Duration Timer, an Inactivity Timer, a Retransmission Timer (e.g., in the DL and/or the UL), or Random Access Contention Resolution Timer; a scheduling request is sent (e.g., on PUCCH) and is pending; or a PDCCH indicating a new transmission addressed to a cell-radio network temporary identifier (C-RNTI) of a MAC entity of the WTRU has not been received after successful reception of a Random Access Response for the Random Access Preamble not selected by the MAC entity among the contention-based Random Access Preamble.

A DRX timer may be a timer associated with DRX. One or more of the following timers may be associated with DRX: DRX on duration timer (e.g., drx-onDurationTimer); DRX inactivity timer (e.g., drx-InactivityTimer); DRX DL retransmission timer (e.g., drx-RetransmissionTimerDL); DRX UL retransmission timer (e.g., drx-RetransmissionTimerUL); DRX HARQ RTT timer for UL (e.g., drx-HARQ-RTT-TimerUL); or DRX HARQ RTT timer for DL (e.g., drx-HARQ-RTT-TimerDL).

A DRX inactivity time or timer may be a duration after a PDCCH occasion in which a PDCCH indicates an initial UL or DL user data transmission for the MAC entity. A DRX DL retransmission timer (e.g., per DL HARQ process) may be the maximum duration until a DL retransmission is received. A DRX UL retransmission timer (e.g., per UL HARQ process) may be the maximum duration until a grant for UL retransmission may be received. DRX HARQ RTT timer for UL (e.g., per UL HARQ process) may be the minimum duration before a UL HARQ retransmission grant may be expected by the WTRU or MAC entity. DRX HARQ RTT timer for DL (e.g., per DL HARQ process) may be the minimum duration before a DL assignment for HARQ retransmission may be expected by the WTRU or MAC entity.

A WTRU may use DRX in an RRC_IDLE state and an RRC_INACTIVE state to reduce power consumption. The WTRU may monitor one paging occasion (PO) per DRX cycle. A PO may be a set of PDCCH monitoring occasions and may comprise multiple time slots (e.g. subframe or OFDM symbol) where a paging downlink control information (DCI) may be sent. One paging frame (PF) may be one radio frame and may contain one or multiple PO(s) or starting point of a PO. A WTRU using an extended DRX cycle (eDRX) may monitor multiple paging occasions per eDRX cycle falling within one paging time window (PTW) per eDRX cycle.

In multi-beam operations, a WTRU may assume that the same paging message and the same Short Message may be repeated in all transmitted beams and thus the selection of the beam(s) for the reception of the paging message and Short Message may be up to WTRU implementation. The paging message may be the same for both RAN initiated paging and CN initiated paging.

A WTRU may initiate an RRC Connection Resume procedure upon receiving RAN initiated paging. If the WTRU receives a CN initiated paging in an RRC_INACTIVE state, the WTRU may move to RRC_IDLE and informs NAS.

When SearchSpaceId other than zero is configured for pagingSearchSpace, the WTRU may monitor the (i_s+1)^{th} PO. A PO may be a set of ‘S*X’ consecutive PDCCH monitoring occasions where ‘S’ is the number of actual transmitted SSBs determined according to ssb-PositionsinBurst in SIB1 and X is the nrofPDCCH-MonitoringOccasionPerSSB-InPO if configured or is equal to 1 otherwise. The [x*S+K]^{th} PDCCH monitoring occasion for paging in the PO may correspond to the K^{th} transmitted SSB, where x=0,1, . . . , X−1, K=1,2, . . . ,S. The PDCCH monitoring occasions for paging which do not overlap with UL symbols (determined according to tdd-UL-DL-ConfigurationCommon) may be sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. If X>1, when the WTRU detects a PDCCH transmission addressed to P-RNTI within its PO, the WTRU may not be required to monitor the subsequent PDCCH monitoring occasions for this PO.

The following parameters are used for the calculation of the PF and i_s above: .T:DRX cycle of the WTRU (T is determined by the shortest of the WTRU specific DRX value(s), if configured by RRC and/or upper layers, and a default DRX value broadcast in system information. In RRC_IDLE state, if WTRU specific DRX is not configured by upper layers, the default value may be applied); N: number of total paging frames in T; Ns: number of paging occasions for a PF; PF_offset: offset used for PF determination; WTRU_ID: 5G-S-TMSI mod 1024.

Parameters Ns, nAndPagingFrameOffset, nrofPDCCH-MonitoringOccasionPerSSB-InPO, and the length of default DRX Cycle may be signaled in a system information block (SIB) (e.g. SIB1). The values of N and PF_offset may be derived from the parameter nAndPagingFrameOffset. The parameter first-PDCCH-MonitoringOccasionOfPO may be signaled in SIB1 for paging in initial DL BWP. For paging in a DL BWP other than the initial DL BWP, the parameter first-PDCCH-MonitoringOccasionOfPO may be signaled in a corresponding BWP configuration.

If a WTRU has no 5G-S-TMSI, for example when the WTRU has not yet registered with the network, the WTRU may use as default identity WTRU_ID =0 in the PF and i_s formulas above.

A WTRU may monitor for or listen to a paging message to know about one or more of incoming calls, a system information change, an ETWS (Earthquake and Tsunami Warning Service) notification for ETWS capable WTRU, a Commercial Mobile Alert System (CMAS) notification and Extended Access Barring parameters modification.

In an RRC Idle state, the WTRU may monitor Short Messages transmitted with a paging RNTI (P-RNTI) over DCI and may monitor a Paging channel for CN paging using a 5G-S-TMSI. In an RRC Inactive state, the WTRU may monitor Short Messages transmitted with a P-RNTI over DCI and may monitor a paging channel for CN paging using a 5G-S-TMSI and RAN paging using a 5G NR inactive RNIT (I-RNTI). In an RRC Connected state, a WTRU may monitor Short Messages transmitted with a P-RNTI over DCI.

A wake-up signal (WUS) and/or a go-to-sleep signal (GOS) may be used, for example with a DRX operation. A WUS/GOS may be associated with one or more DRX cycles. A WUS/GOS may be transmitted and/or received prior to an associated time or part of a (e.g., an associated) DRX cycle.

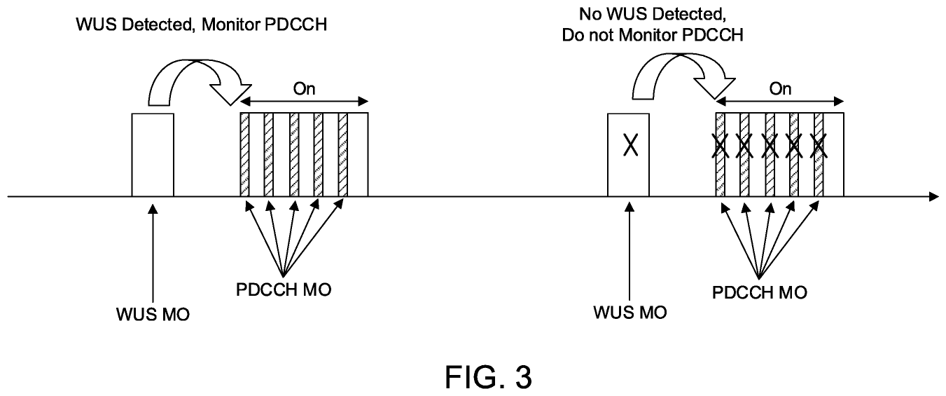

FIG. 3 shows an example of a connected mode WUS. If a WTRU detects a WUS, for example during a WUS monitoring occasion (MO), the WTRU may monitor for a PDCCH during, for example, PDCCH monitoring occasions (MOs). If the WTRU does not detect a WUS, the WTRU may not monitor for a PDCCH.

A WTRU may be configured to monitor for downlink control information, for example DCI Format 2_6, in a common search space, before an ON duration. If the WTRU is provided with a 1-bit flag ps-WakeupOrNot, the WTRU is indicated by ps-WakeupOrNot whether the WTRU may not start or whether the WTRU shall start the drx-onDurationTimer for the next DRX cycle. If the WTRU is not provided with a 1-bit flag ps-WakeupOrNot, the WTRU may not start Active Time indicated by drx-onDurationTimer for the next DRX cycle.

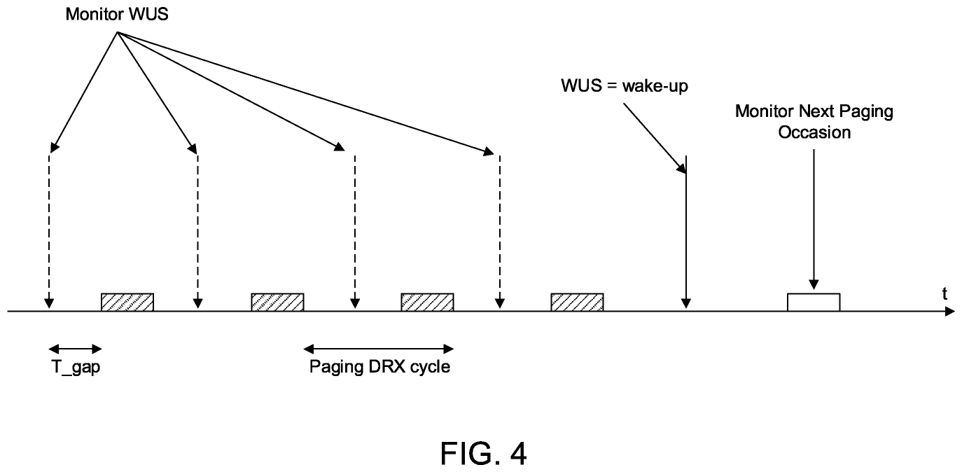

FIG. 4 shows an example of an Idle mode WUS. A WUS for Idle mode paging was introduced for WTRU supporting NB-IoT or eMTC. The WTRU may monitor for a WUS at a time specified by T_gap before a paging occasion. If the WTRU receives an indication that there may be paging addressed to that WTRU in the next paging time window then the WTRU may monitor a PDCCH during each paging occasion of that paging time window. The paging time window is defined such that WTRUs with a very long DRX period (e.g. in the order of minutes) (i.e. eDRX), and which may suffer from clock drift compared to the network timing, may reliably receive paging.

A WUS for Idle mode paging is desirable. A paging early indication (PEI) transmitted prior to a WTRU paging occasion may indicate whether the WTRU should monitor a PDCCH and potentially PDSCH to receive a paging message.

Support for a low-power wake-up receiver is desirable in order to further reduce the power consumption by supporting devices, by allowing a WTRU to power down or “sleep” the main receiver and monitor for a wake-up signal using a low-power wake up receiver, only utilizing the main receiver when necessary. This may address, for example, the following requirements: industrial wireless sensors, where the battery should last at least few years; wearables where the battery of a wearable device should last multiple days (e.g. up to 1-2 weeks); and IDLE mode power consumption for 5G smartphone is expected to be further improved.

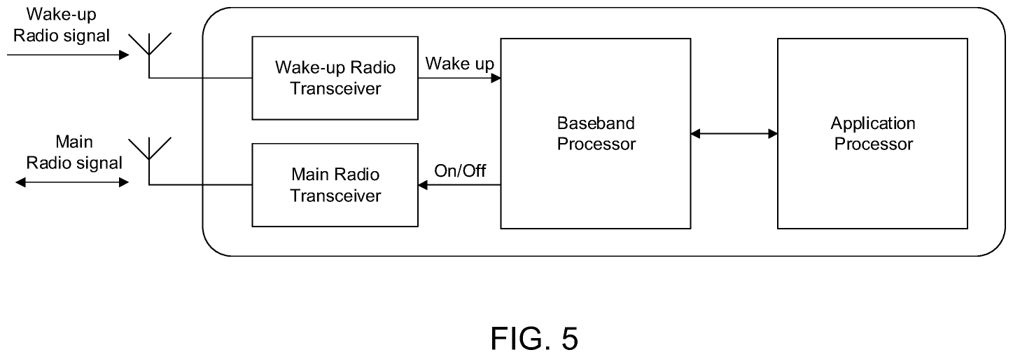

FIG. 5 shows an example of a simplified architecture utilizing a low-power wake-up receiver (WUR). A wake-up radio transceiver may receive a wake-up radio signal and may send a wake-up command to a baseband processor. The baseband processor may send an on command or an off command to a main radio transceiver and the main radio transceiver may send or receive a main radio signal. The baseband processor may communicate with an application processor. For Idle mode, the WTRU may need to monitor for the wake-up signal prior to paging occasions in order to determine whether to switch on a main receiver to decode a PDCCH and receive paging.

In Idle mode, serving cell and neighbor cell measurements may be important for ensuring the WTRU mobility (i.e. to ensure a WTRU remains in coverage of the best cell and is always reachable (i.e. may be paged) by the network and may initiate a call).

DRX operation and WUS operation is designed to work using a main radio transceiver. This allows a WTRU to perform measurements (e.g. reference signal received power (RSRP) and reference signal received quality (RSRQ) measurements) on the serving cell and, when needed, neighbor cells using reference symbols transmitted by the cell(s) during the times when the main receiver is required to monitor for paging on a PDCCH.

With the introduction of support for a low-power wake-up receiver, it is desirable for the main receiver to be allowed to power down or “sleep” for extended durations of time. It is expected that any measurements that may be performed on the wake-up signal using the low-power receiver may be significantly less accurate, and may be performed using a different modulation and coding scheme and potentially on a different carrier frequency and using different reference symbols than the main signal. The complexity, and hence the amount of information conveyed, by the low power wake-up signal should be minimized in order to ensure it is as power efficient as possible. This means that the wake-up signal should not be used alone to accurately estimate the quality of the main cell signal.

It is important that some means of performing serving cell measurements using the main receiver is defined even while a WTRU is saving power by monitoring a low power wake-up signal using a low power receiver, in order to maintain a reasonable level of reliability in Idle mode serving cell monitoring and cell reselection.

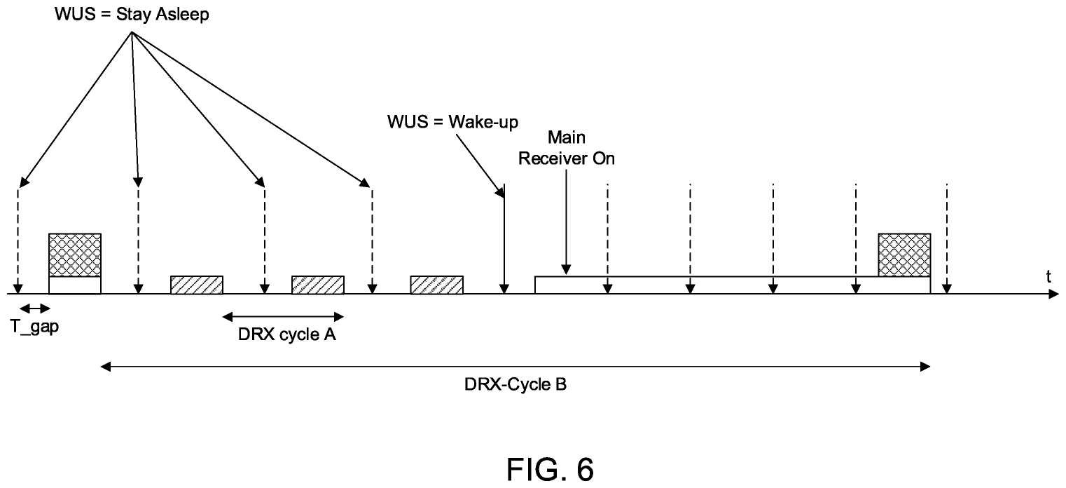

FIG. 6 shows an example of dual DRX. In an embodiment, a WTRU may be configured with at least two DRX cycles. A first DRX cycle (e.g. DRX cycle A) may have a first periodicity and may correspond to a regular Idle mode DRX cycle, and may be configured in a cell specific manner (e.g. using system information), or may be WTRU specific and configured using dedicated signaling. A second DRX cycle (e.g. DRX cycle B) may have a second periodicity and may correspond to an eDRX configuration and be longer than DRX cycle A.

A WTRU may monitor for a WUS (e.g., with a low power wake-up radio receiver (WUR)) based on a timing of DRX cycle A with the main receiver in “sleep” mode. The WUS signal may occur at a predefined or configured time prior to and relative to the start of a next DRX ON duration. When the WTRU receives the WUS (e.g. WUS=wake-up) the WTRU may power up the main receiver and monitor for a PDCCH starting at a beginning of an ON duration time specified according to the DRX in normal operation conditions. The WTRU may receive scheduled data according to the PDCCH and switch on continuous reception, which may normally comprise of a paging message and a paging response which may trigger an RRC connection establishment.

A WTRU may perform periodic serving cell and/or radio resource management (RRM) measurements and monitor for paging based on the DRX cycle B timing using the main receiver.

While the existing DRX in connected mode uses two DRX cycles (long and short), the procedure for switching between the two DRX cycles is based on a timer expiration and detection of scheduled data on a PDCCH. The detection of data is done using the main receiver. With the embodiment in FIG. 6, there are two DRX cycles. DRX cycle A is used by a low power wake up receiver. The DRX cycle used by a main receiver is switched between cycle A or cycle B based on a status of the low power wake up receiver.

When a “wake-up” indication is received by the low power wake up receiver (i.e. WUS=wake-up), the main receiver may be switched on and the WTRU may attempt to decode a PDCCH using, for example a P-RNTI, in the next paging occasion according to the first DRX cycle. If the WTRU detects a DCI scheduling a PDSCH using the P-RNTI, the WTRU may decode the paging message on the PDSCH. If the paging message contains the WTRU identity, the WTRU may initiate a random access procedure in order to respond to the paging. During the random access procedure, the WTRU may first transmit a random access preamble (Msg1) on a physical random access channel (PRACH). The network may respond with a random access response (RAR) (Msg2) using the same identifier as the WTRU provided in Msg1. If the WTRU receives a RAR with the same identifier as Msg1, the WTRU may send an RRC Connection request (Msg3) using the resources scheduled in Msg2. If the network receives Msg3, it may respond with an RRC Connection Setup (Msg4) which may provide dedicated resources to the WTRU, and the WTRU may respond with a RRC Connection Setup Complete (Msg5) to complete the RRC Connection Establishment allowing data to be sent and received using dedicated resources specific to the WTRU.

In an embodiment, the WTRU may be configured with one DRX cycle (e.g., DRX cycle A) and may determine the timing of the second set of paging occasions (e.g. DRX cycle B) periodically. A WUS search space may be determined based on DRX cycle A periodicity and/or on duration timing.

DRX cycle B is primarily intended to ensure that the WTRU performs RRM measurements on a regular basis using the main receiver. The WTRU may perform RRM measurements according to DRX cycle B, while decoding a PDCCH only based on the WUS, or alternatively the WTRU may perform both RRM measurements and PDCCH decoding based on DRX cycle B, while performing RRM measurements and PDCCH decoding on the DRX cycle A occasions only when DRX cycle A has been triggered (based on WUS, or as described in the following sections based on WUS quality monitoring).

An advantage of this embodiment is that it allows the WTRU to obtain a power saving benefit of an eDRX (long) cycle, while maintaining a latency benefit of a DRX (short) cycle and maintaining the regular serving cell monitoring using the main receiver to allow robust and reliable mobility. Another advantage is that it allows eDRX (long) cycles to be supported without impacting the core network functionality. One of the reasons that DRX cycles above 10.24 s is not supported currently is due to the need for the core network to know the timing of WTRU paging occasions. Since a gNB is enabled to perform paging according to the short DRX cycle, the long eDRX (or even “virtual eDRX”) may be utilized in RAN while being transparent to the CN.

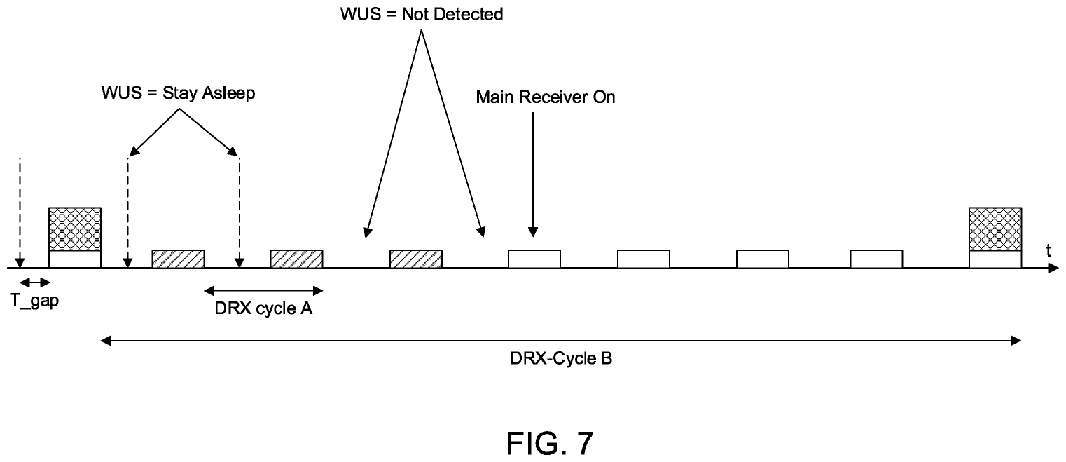

For robustness, the WTRU may monitor WUS quality. If predefined condition(s) are met, the WTRU may switch the main receiver on and monitor paging and perform measurements according to DRX cycle A. As shown in FIG. 7, a fallback procedure provides robustness both in terms of paging monitoring and in terms of cell coverage (i.e. mobility). If a WUS is detected to be unreliable, the WTRU may switch to normal operation of the main receiver. Conditions for unreliability may include: a WUS quality is below a threshold (e.g. over a period) or a WUS cannot be detected (e.g. over a period). For example, the WUS may be undetectable for a number of occasions (N) which may be configurable or predefined.

The WUS signal may comprise at least two parts. One part may indicate the presence of a WUS signal and the other part may indicate a particular WTRU or a group of WTRUs to be paged in a next paging reception occasion. The presence of a WUS signal part may signal for example, an identity of cell or a field to be measured by the WTRU. The WUS signal comprising the two parts may be sent periodically and a WTRU may expect to receive the WUS at a preconfigured time occasion.

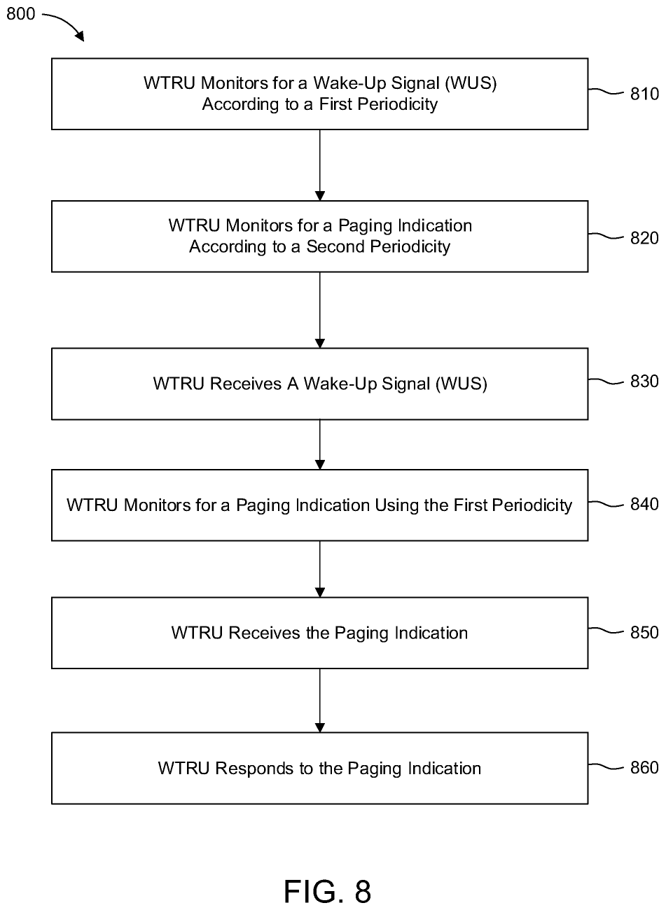

FIG. 8 shows a method for DRX using a low power wake up signal. The WTRU may monitor for a wake-up signal (WUS) according to a first periodicity (810). The first periodicity may be associated with a first DRX cycle. The WUS may be a low power WUS. The WTRU may monitor for the WUS using a low power wake-up receiver (WUR). The WUS may have a first waveform type. For example, the WUS may have a non-OFDM waveform. The WTRU may monitor for a paging indication according to a second periodicity (820). The second periodicity may be associated with a second DRX cycle. The second periodicity may be longer than the first periodicity. The WTRU may monitor for a paging indication using a main receiver. The paging indication may be in a downlink control information (DCI). The DCI may be sent over a PDCCH. The paging indication may be sent in a second waveform type. For example, the second waveform type may be OFDM. The WTRU may receive or detect a WUS (830). The WUS may indicate that the main receiver should wake up. In response to receiving the WUS, the WTRU may monitor for a paging indication using the first periodicity (840). In other words, the main receiver switches from the second periodicity to the first periodicity for monitoring for a paging indication. The WTRU may receive the paging indication (850). The WTRU may respond to the paging indication, for example by performing a RACH procedure and transmitting data over a physical random access channel (PRACH) (860).

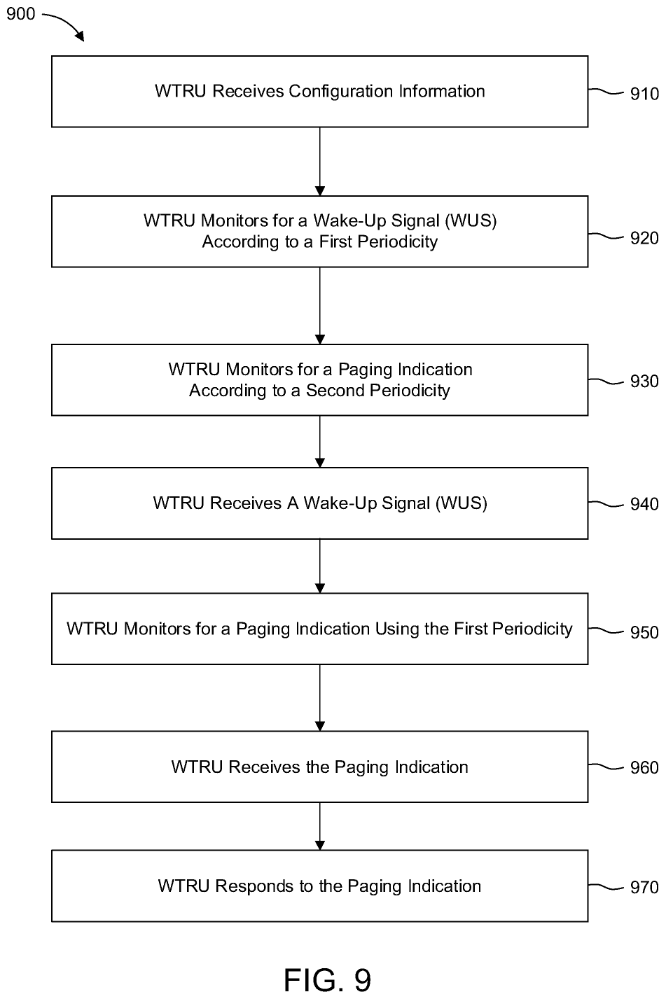

FIG. 9 shows a method for DRX using a low power wake up signal. A WTRU may receive configuration information (910). The configuration information may comprise information regarding a first DRX cycle with a first periodicity and a second DRX cycle with a second periodicity. The second periodicity may be longer than the first periodicity. The configuration information may comprise a time offset value (T). The time offset value (T) may be a period of time to allow a main receiver to turn on or be activated. The configuration information may comprise a threshold value for WUS detection. The configuration information may comprise a number (N) of monitoring occasions for missed WUS detections. The WTRU may monitor for a wake-up signal (WUS) according to the first periodicity (920). The WUS may be a low power WUS. The WTRU may monitor for the WUS using a low power wake-up receiver (WUR). The WUS may have a first waveform type. For example, the WUS may have a non-OFDM waveform. The WTRU may monitor for a paging indication according to the second periodicity (930). The WTRU may monitor for a paging indication using a main receiver. The paging indication may be in a downlink control information (DCI). The DCI may be sent over a PDCCH. The paging indication may be sent in a second waveform type. For example, the second waveform type may be OFDM. The WTRU may receive or detect a WUS (940). The WUS may indicate that the main receiver should wake up. In response to receiving the WUS, the WTRU may monitor for a paging indication using the first periodicity (950). In other words, the main receiver switches from the second periodicity to the first periodicity for monitoring for a paging indication. The WTRU may monitor for a paging indication after the time offset value (T) from receiving the WUS. The WTRU may receive the paging indication (960). The WTRU may respond to the paging indication, for example by performing a RACH procedure and transmitting data over a physical random access channel (PRACH) (970).

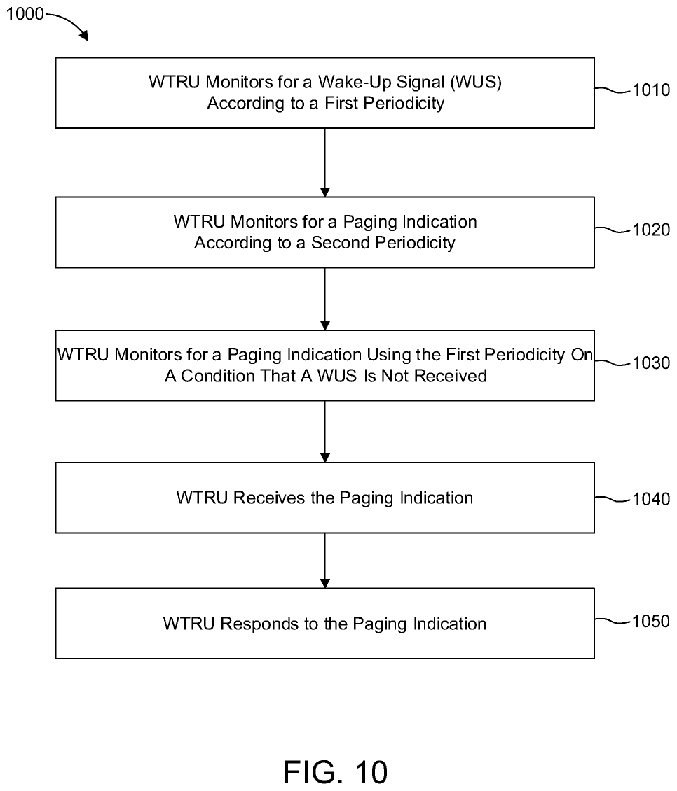

FIG. 10 shows a method for DRX using a low power wake up signal. The WTRU may monitor for a wake-up signal (WUS) according to a first periodicity (1010). The first periodicity may be associated with a first DRX cycle. The WUS may be a low power WUS. The WTRU may monitor for the WUS using a low power wake-up receiver (WUR). The WUS may have a first waveform type. For example, the WUS may have a non-OFDM waveform. The WTRU may monitor for a paging indication according to a second periodicity (1020). The second periodicity may be associated with a second DRX cycle. The second periodicity may be longer than the first periodicity. The WTRU may monitor for a paging indication using a main receiver. The paging indication may be in a downlink control information (DCI). The DCI may be sent over a PDCCH. The paging indication may be sent in a second waveform type. For example, the second waveform type may be OFDM. The WTRU may monitor for a paging indication using the first periodicity on a condition that a WUS is not received or detected (1030). In other words, the main receiver switches from the second periodicity to the first periodicity to monitor for a paging indication. The WTRU may receive the paging indication (1040). The WTRU may respond to the paging indication, for example by performing a RACH procedure and transmitting data over a physical random access channel (PRACH) (1050).

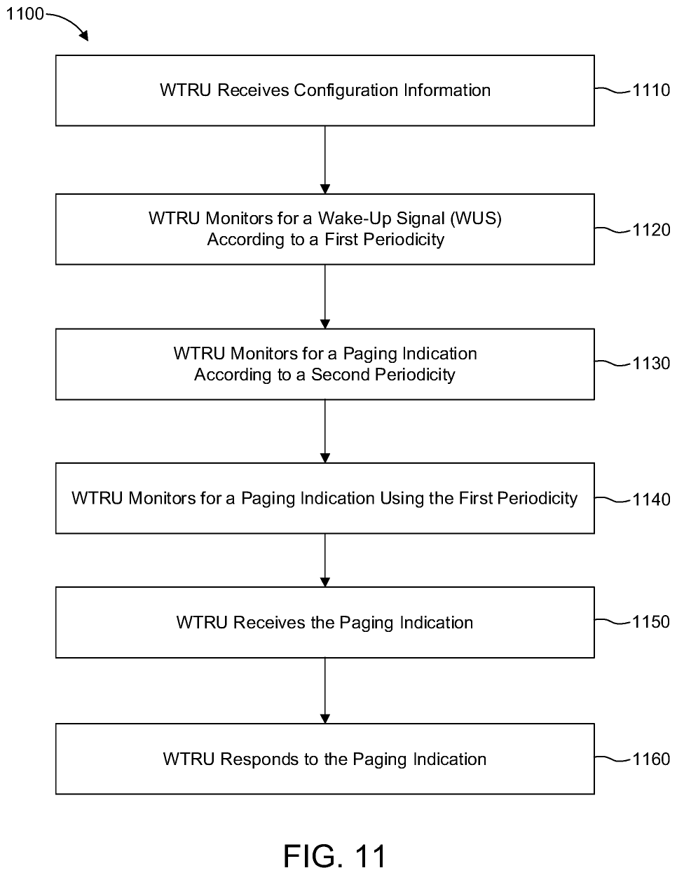

FIG. 11 shows a method for DRX using a low power wake up signal. A WTRU may receive configuration information (1110). The configuration information may comprise information regarding a first DRX cycle with a first periodicity and a second DRX cycle with a second periodicity. The second periodicity may be longer than the first periodicity. The configuration information may comprise a time offset value (T). The time offset value (T) may be a period of time to allow a main receiver to turn on or be activated. The configuration information may comprise a threshold value for WUS detection. The configuration information may comprise a number (N) of monitoring occasions for missed WUS detections. The WTRU may monitor for a wake-up signal (WUS) according to the first periodicity (1120). The WUS may be a low power WUS. The WTRU may monitor for the WUS using a low power wake-up receiver (WUR). The WUS may have a first waveform type. For example, the WUS may have a non-OFDM waveform. The WTRU may monitor for a paging indication according to the second periodicity (1130). The WTRU may monitor for a paging indication using a main receiver. The paging indication may be in a downlink control information (DCI). The DCI may be sent over a PDCCH. The paging indication may be sent in a second waveform type. For example, the second waveform type may be OFDM. The WTRU may monitor for a paging indication using the first periodicity (1140). In other words, the main receiver switches from the second periodicity to the first periodicity to monitor for a paging indication. The WTRU may monitor for the paging indication using the first periodicity on a condition that a WUS is not received or detected. The WTRU may monitor for the paging indication using the first periodicity on a condition that a measurement of the WUS is less than the threshold value for WUS detection for the N consecutive monitoring occasions. The WTRU may monitor for the paging indication after the time offset value (T) from the time of the Nth monitoring occasion (i.e. Nth missed or not detected WUS). The WTRU may receive the paging indication (1150). The WTRU may respond to the paging indication, for example by performing a RACH procedure and transmitting data over a physical random access channel (PRACH) (1160).

The WUS may be used to maintain timing synchronization to the main signal, reducing the synchronization time when powering on the main receiver, and removing the need to define paging time windows (PTW) to address the loss of timing synchronization during an eDRX on duration or paging occasions.

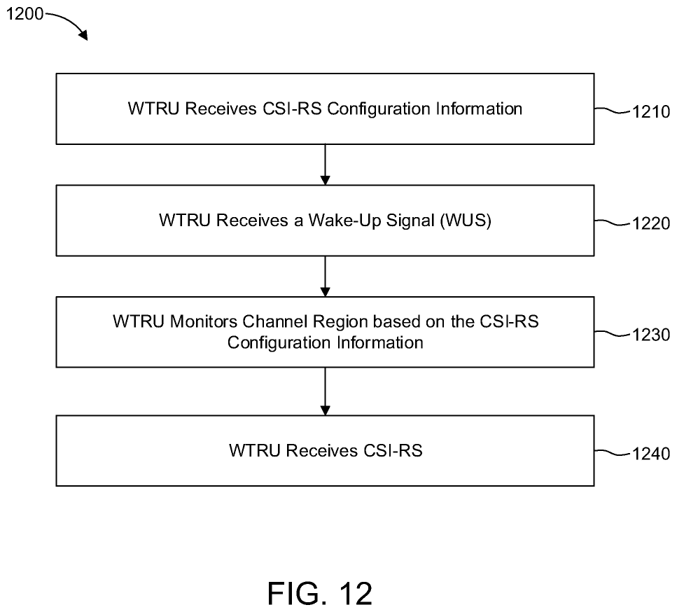

FIG. 12 shows an example method of rapid synch. A WTRU may receive configuration information (1210). The configuration information may be channel state information-reference signal (CSI-RS) configuration information. The configuration information may be received from a gNB. A gNB may broadcast in SIBs a specific CSI-RS configuration that is related to a WUR/WUS capable WTRU. This CSI-RS configuration may be configured per bandwidth part (BWP) or a specific channel region if the WTRU is configured to wake up and monitor a specific BWP. The CSI-RS configuration may be used by the gNB to speed up the synchronization of the WTRU and AGC settling. The WTRU may receive a wake-up signal (WUS) (i.e. wake-up command) (1220). After the WTRU detects the WUS the WTRU may wake up its main receiver and start monitoring a channel region indicated by the CSI-RS configuration information (1230). The WTRU may receive a CSI-RS (1240). The CSI-RS may be transmitted in a single shot or it may be transmitted in a burst of several CSI-RS symbols. The multiple CSI-RS symbols in a burst may be related to a fast synchronization requirement. Some WTRU may have a shorter synchronization requirement. This may be signaled by the WTRU as a capability. When such a WTRU is camped on a WUS capable gNB, the gNB may configure burst CSI-RS symbols for these WTRU. The first symbol containing CSI-RS may be transmitted after the WUS signal at a specific time. For example, it may be transmitted 1 or 2 symbols following the WUS (wake-up command) or it may be transmitted based on a WTRU capability declared interval related to its receiver wakeup time. After the CSI-RS symbol or symbol burst, the WTRU may be considered synchronized, and the next paging occasion may be used by the gNB for WTRU paging and the follow up procedure for data transfer.

Use of a signal such as a CSI-RS in one or more symbols for synchronization may be referred to herein as rapid synchronization (i.e. rapid sync). Rapid sync may be one-shot (e.g., in one symbol or time unit) or a burst (e.g., in multiple symbols or time units) which may be referred to herein as one-shot rapid sync and burst rapid sync, respectively.

A WTRU may use a random access procedure (RACH) or part of a RACH to do, for example, one or more of the following: indicate information related to the WTRU's WUR/WUS capabilities, request a WUS, indicate whether the WTRU is in WUS coverage or not.

A WTRU may transmit a preamble using a PRACH or other resource. The preamble transmission may be referred to as MSG1. The WTRU may receive a random access response (RAR) that may be referred to as MSG2. The RAR may include an UL grant for resources. The WTRU may use the resources indicated by the UL grant to send a message that may be referred to as MSG3.

The terms WUS/WUR may be used to represent WUS and/or WUR. WUS/WUR information and WTRU WUS/WUR information may be used interchangeably herein. The terms send and transmit may be used interchangeably herein.

A set of one or more preambles and/or one or more resources (e.g., time and/or frequency resources) may be configured for indicating WTRU WUS/WUR information. The set of preambles may be referred to herein as WUS/WUR preambles. The set of resources may be referred to herein as WUS/WUR physical random access channel (PRACH) resources.

The preamble and/or resources configuration may be received by a WTRU via system information that may be broadcast, for example by a gNB. The WTRU may select (e.g., randomly) and/or may send a preamble from the set of WUS/WUS preambles, in order to, for example, indicate WTRU WUS/WUR information or to indicate that the reason for the preamble transmission is related to WTRU WUS/WUR information. The WTRU may use a WUS/WUR PRACH resource for a preamble transmission, for example, to indicate WTRU WUS/WUR information or to indicate that the reason for the preamble transmission is related to WTRU WUS/WUR information. The preamble may be from the set of WUS/WUR preambles or from another set.

The WTRU may receive a RAR in response to the preamble transmission. The WTRU may send a message (e.g., MSG3) using resources granted by the RAR. The message may include WTRU WUS/WUR information.

The WTRU may send the preamble and a message and receive a RAR in response to the combination of the preamble and message. The combined preamble and message may be referred to herein as MSGA. The message (e.g., the message portion of MSGA) may include WTRU WUS/WUR information.

MSG3 may be sent on a physical UL shared channel (PUSCH). The message portion of MSGA may be sent on a PUSCH. The message portion of MSGA may contain a MSG3.

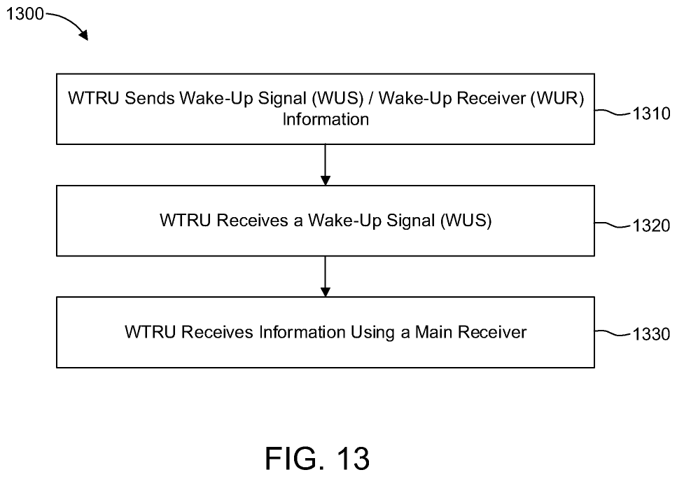

FIG. 13 shows an example method of wake-up signal (WUS) configuration. A WTRU may send or transmit WTRU WUS/WUR information via a (e.g. any) message or indication (1310). The WTRU may send or transmit WTRU WUS/WUR information via an UL channel or signal such as a PUSCH, PUCCH, PRACH, or sounding reference signal (SRS). The WTRU may send or transmit WTRU WUS/WUR information via a preamble (e.g. MSG1), or UL control information (UCI) or a reference signal (RS) such as a demodulation reference signal (DM-RS).

The WTRU may send WTRU WUS/WUR information while in one or more of: Idle Mode, Inactive State, RRC connected state or mode, among others. The WTRU may send WTRU WUR/WUS information to a cell, gNB, and/or other node or entity such as a network node or entity. The WTRU may send WTRU WUR/WUS information to another WTRU.

WTRU WUS/WUR information may include one or more of the following: a WUS/WUR capability such as an indication that WUS/WUR is supported by the WTRU; a WUS/WUR capability or other indication to indicate that a WUS/WUR WTRU is camped on the cell; WUS/WUR coverage information which may indicate whether or not the WTRU is in coverage of a WUS or other signal that may be transmitted by the gNB or cell and/or received by the WTRU; a WUS/WUR identity or group identity (e.g. group ID); or a request for a WUS.

The WTRU may determine in coverage vs. not in coverage based on a measurement performed by the WTRU. The measurement may be of a WUS or other signal. The measurement may be made in one or more resources configured or indicated as configured for a WUS or other signal. The configuration of the resources and/or other parameters the WTRU may use for making the measurement may be received by the WTRU is system information or other signaling such as RRC signaling.

WTRU WUS/WUR information may include one or more of the following: a request for a rapid sync (e.g. CSI-RS rapid sync) transmission; a request for or WTRU capability to support a type of rapid sync such as one-shot (e.g. one-shot CSI-RS) or burst (e.g. burst CSI-RS); a rapid sync capability (e.g., of the WTRU) or timing such as a rapid sync signal period or periodicity and/or a rapid sync burst length in time; a WUS/WUR timing capability such as a time (e.g., minimum time) needed by the WTRU between a WUS and a first CSI-RS where such time interval may be a WTRU cold start interval; and a WUS/WUR timing capability such as a time (e.g. minimum time) interval for reception of a CSI-RS (e.g. a first CSI-RS) after reception of a WUS.

The WTRU may receive a WUS (1320). After receiving a WUS, the WTRU may need time to wake-up or activate various components that may be sleeping or inactive. The WTRU may receive information using a main receiver (1330). Depending on how deep the sleep is (e.g., the level of component inactivity) it may take the WTRU varying amounts of time to be ready to receive (e.g., successfully receive and/or decode) a signal or information over a channel such as a rapid sync signal (e.g. CSI-RS) or a PDCCH.

The amount of time (e.g. the minimum amount of time) that the WTRU may need to receive a signal or information over a channel (e.g. after a WUS) may be a WTRU WUS/WUR capability or WTRU WUS/WUR timing capability that the WTRU may send to, for example a gNB, cell, or other network node or entity.

A WUS/WUR timing capability may be in terms of a numbers of symbols and/or a numbers of slots. A WUS/WUR timing capability may be a time from the WUS (e.g., from the WUS reception, the start of the WUS reception or the end of the WUS reception) to a time (e.g. first symbol, first slot and/or start) of a first signal or RS (e.g. CSI-RS) of a rapid sync transmission (one-shot or burst) that the WTRU may be ready to receive. This may be a WTRU cold start interval or capability.

A WUS/WUR timing capability may be a time from the WUS (e.g. from the WUS reception, the start of the WUS reception or the end of the WUS reception) to a time (e.g. first symbol, first slot, and/or start) of a PDCCH transmission (e.g. a first PDCCH transmission) that the WTRU may be ready to receive, for example without rapid (e.g. CSI-RS) sync.

A WUS/WUR timing capability may be a time from the WUS (e.g. from the WUS reception, the start of the WUS reception or the end of the WUS reception) to a time when (e.g. the first symbol and/or first slot) the WTRU may begin monitoring for a PDCCH.

A WTRU may determine that a cell (e.g. a first cell) is WUR/WUS capable and/or rapid sync (e.g. CSI-RS rapid sync) capable for example from system information (SI). The WTRU may receive the SI and use the information in the SI for the determination. The SI may be received from the first cell. The SI (e.g. the SI related to the capabilities of the first cell) may be received from a second cell.

In an example, a WTRU may determine that a cell is WUR/WUS capable and/or capable of a rapid synchronization (sync) procedure after camping on the cell and receiving SI (e.g. SI that comprises such capability information) from the cell. Rapid sync may use CSI-RS and may be referred to herein as a CSI-RS rapid sync. CSI-RS is used herein as a non-limiting example of a signal that may be used for performing or achieving rapid sync. Any other signal may be used and still be consistent with this disclosure and the examples and embodiments described herein.

The rapid sync (e.g. CSI-RS rapid sync) capability (e.g. of a cell) may be indicated as supported and/or active (e.g. ON) in the SI (e.g. of the cell). WUS capability (e.g. of a cell) may be indicated as supported and/or active (e.g. ON) in the SI (e.g. of the cell).

The WTRU may request or resume an RRC connection in order to provide or send WTRU WUS/WUR information (e.g. to a cell, gNB, or other network entity). The WTRU may send WTRU WUS/WUR information without an RRC connection or with an inactive RRC connection.

A WTRU may send WTRU WUS/WUR information (e.g. to a cell) when the WTRU determines (e.g. from SI) that the cell is WUS/WUR capable and/or capable of a rapid synchronization (sync). The WTRU may, for example, send the WTRU WUS/WUR when the WTRU detects (e.g. successfully receives) a WUS from the cell or when the WTRU does not detect or does not successfully receive the WUS from the cell. The WTRU may determine detection or successful reception based on one or more measurements for example measurements in a time window or over a time period. The time window or period over which to make the measurements for the determination may be configured or received (e.g. from the cell such as in SI).

In an embodiment, a WTRU may send WTRU WUS/WUR information to a cell when the WTRU does not detect a WUS from the cell. The WTRU may send the WTRU WUS/WUR information to the cell when the WTRU determines the cell is WUS/WUR capable. The WTRU may send the WUS/WUR to request the cell to transmit a WUS.

In an embodiment, a WTRU may send WTRU WUS/WUR information to a cell when the WTRU does not detect a rapid sync signal from the cell. The WTRU may send the WTRU WUS/WUR information when the rapid sync signal is detected by the WTRU but is not sufficient (e.g. as determined by the WTRU) for use by the WTRU. For example, the WTRU may send the WUS/WUR information to indicate or request a different type of rapid sync signal than the one being transmitted or received. The WTRU may send the WUS/WUR information to indicate or request a different timing (e.g. minimum timing) for the rapid sync signal than the timing of the rapid sync signal being transmitted or received.

Subsequent to a WTRU sending WTRU WUS/WUS information (e.g. to a cell), the WTRU may receive a WUS or rapid sync signal and use the WUS or rapid sync signal as described herein, for example to wake-up and/or synchronize with one or more signals of the cell and then monitor for a PDCCH. The WTRU may monitor for a PDCCH in order to receive a page or a grant. The WTRU may respond to the page (e.g. send a PRACH preamble, request or resume an RRC connection, and/or receive an updated SIB). The WTRU may transmit or receive in accordance with the grant.

A WTRU may send WTRU WUS/WUR information to indicate that the WTRU is using or is capable of using one-shot rapid sync or burst rapid sync A WTRU may use a cell update procedure or other procedure to indicate WTRU WUS/WUR information.

A WTRU may use a common control channel (e.g. UL-CCCH) message to indicate WTRU WUS/WUR information. A WTRU may include WTRU WUS/WUR information in an UL-CCCH message. MSG3 or the message part of MSGA may carry an UL-CCCH message. A WTRU may use a MAC control element (MAC-CE) to indicate WTRU WUS/WUR information. A WTRU may include WTRU WUS/WUR information in the MAC-CE. The WTRU may transmit an UL-CCCH message. The WTRU may transmit a MAC-CE.

A WTRU may indicate a reason or cause for sending a preamble or a message such as a MSG1, a MSG3, a MSGA, an UL-CCCH message, an RRC request, an RRS resume request, an RRC connection reestablishment request and/or a cell update. The indicated reason may be at least one of the following: WUS capable WTRU is present (e.g. camped on the cell or receiving from the cell); WUS is out of coverage (e.g. WUS not detected or below a threshold); WUS is in coverage (e.g. WUS detected or above a threshold); rapid sync (e.g. rapid sync signal) is out of coverage; rapid sync (e.g. rapid sync signal) is in coverage.

A WTRU may determine that a signal is out of coverage when the signal is not detected or a measurement of the signal is below a threshold. A WTRU may determine that a signal is in coverage when the signal is detected or a measurement of the signal is above a threshold.

A WTRU may receive a response from a cell or gNB. The response may be included in a RAR. The response may be provided in another message. The response may be provided in a MAC-CE. The response may acknowledge an indication or request from the WTRU. The response may confirm that the cell or gNB will transmit a WUS or rapid sync signal, for example in accordance with the indication or request sent by the WTRU.

The response may indicate one or more of the following: WUS indication or request from the WTRU is acknowledged; WUS operation is accepted, meaning for example that a WUS is or will be transmitted; a WUS is or will be transmitted and the WTRU indicated parameters/capabilities were accepted (e.g. the WUS is or will be transmitted based on, according to, or in a way that satisfies, the WTRU indicated parameters/capabilities); WUS and rapid sync operation are accepted; WUS and rapid sync signal(s) are or will be transmitted; WUS operation is accepted without rapid sync; WUS is or will be transmitted and rapid sync signal(s) are not transmitted; WUS operation denied; and WUS is not being transmitted.

The WTRU may perform actions after receiving the response from the cell or gNB based on the response received from the cell or gNB. For example, if the response indicates WUS usage, transmission or activation, the WTRU may use the WUS. If the response indicates rapid sync signal usage, transmission or activation, the WTRU may use the rapid sync signal.

The WTRU may or may only use the WUS if the response indicates WUS usage, transmission or activation in accordance with the WTRU's request or in accordance with the WTRU WUS/WUR information it transmitted.

The WTRU may or may only use the rapid sync signal if the response indicates rapid sync signal usage, transmission or activation in accordance with the WTRU request or in accordance with the WTRU WUS/WUR information it transmitted.

If WUS operation is denied or the WUS is indicated as not transmitted, the WTRU may use or return to normal DRX operation without considering WUS/WUR activity. For example, if WUS operation is denied or the WUS is indicated as not transmitted, the WTRU may use its DRX cycle (e.g. without monitoring for the WUS) to determine when to monitor for a PDCCH. For example, if the WUS operation conditions are all accepted, the WTRU may use the WUS to determine when to monitor for a PDCCH.

The WTRU may use one or more of the following that the WTRU indicated in its WUS/WUR information transmission: the rapid sync period as indicated; PDCCH monitoring starting according to described WUS capability indication after rapid sync or at the next DL slot/symbol opportunity.

If the WUS operation is accepted, but the rapid sync capability is denied, the WTRU may operate under the WUS capability indicated for WUS without rapid sync.

A WTRU may be camped on, receiving signals from, or monitoring for paging from a first cell. The WTRU may determine that a signal quality from a second cell is better than a signal quality from the first cell. The WTRU may determine to perform reselection to the second cell.

A WTRU may send WUS/WUR information in a new serving cell, for example, after cell reselection. The new serving cell may be the second cell. The WTRU may perform a cell update procedure in the new or second cell. The WTRU may indicate the cell change in a message to the second cell. This may enable the network (e.g. RAN) to know a certain WTRU left a previous serving cell, which enabled WUS reception for the WTRU and so the network may utilize the WUS resource used by cell-updated WTRU for the other WTRU.

A cell or gNB may use an ON/OFF indication for WUS operation in its SI. Upon reading a flag during the SI acquisition, a WUS capable WTRU may follow the ON/OFF indication. For example, the WTRU may use the WUS if it is indicated as ON and may not use the WUS if it is indicated as OFF.

A cell or gNB may page one or more WTRUs to indicate a change of state or a change of parameters for a WUS and/or a rapid sync signal(s). The paging indication may comprise a paging DCI that may be carried by a PDCCH and/or a paging message that may be carried by a PDSCH. The paging DCI may include the change information (e.g. as part of a short message). This may be referred to as direct indication. The paging DCI may indicate an SI update.

In an example, the paging DCI may indicate (e.g. direct indication) that the WUS state has changed from ON to OFF or OFF to ON. In another example when one or more WUS parameters provided by the SI are changed, the DCI may indicate an SI update. For direct indication in the DCI, the WTRU may not need to receive updated SI (e.g. from a SIB). When an SI update is indicated, the WTRU may receive the SI (e.g. one or more SIBs) in order to obtain the updated information.

Based on the paging DCI direct indication and/or received updated SI, the WTRU may determine that the WUS is ON or OFF, the rapid sync signal(s) are ON or OFF and one or more parameters for these signals. The WTRU may operate based on the changes.

In an embodiment, if the WUS is ON, the WTRU may use the WUS, for example as described herein. If the WUS is OFF, the WTRU may stop using the WUS. If the WUS is OFF, the WTRU may send WTRU WUS/WUR information to the cell or gNB for example to indicate its capability or to request a WUS. The WTRU may or may only send this information if the WTRU has not already sent this information while camped on the cell or if a time elapsed since the last time the WTRU sent this information (e.g. to this cell or gNB) is greater that a threshold.

A WUS quality may be reported by a WTRU. A cell update may be performed after cell reselection (e.g. to make the cell use a WUS). This may be achieved with a simple signal. A cell update may be sent if (e.g. only if) the WTRU does not see a WUS or the WUS is not good, not in the beam, etc. A cell update may be performed if the WTRU does not see the signal it is expecting. For example, the WTRU does not observe a rate/periodicity of the WUS. A cell update or WUS quality report may be sent in-band or out-of-band. A WUS capability may be sent in the SIB. The WTRU may inform a gNB that it is out of WUS coverage.

A WTRU may monitor a quality of a WUS signal. The WTRU may determine a WUS quality based on a measurement of the WUS (e.g. WUS sequence). The measurement may be similar to RSRP samples of the regular receiver. A WUS energy detector may be used. The resulting measurement may be compared to a WUS signal strength threshold that may be received from the cell or gNB. The threshold may be received in an SI (e.g. a SIB). The WUS quality may be monitored using single measurement samples (e.g. a one shot WUS measurement) or a sliding window of an n number of averaged WUS measurement samples.

A WTRU may detect or determine that a WUS is low quality. The WTRU may detect or determine that the WUS is low quality when for a time interval determined from a WUS periodicity or for a number of WUS occasions the signal quality (e.g. measurement) is under a certain threshold or a certain number of WUS samples were not detected. When the WTRU determines the WUS is low quality, the WTRU may fall back to a regular DRX cycle using the main receiver. The WTRU may wake up its main receiver based on a regular configured DRX and start normal RRM measurements on the cell's synchronization signal blocks (SSBs).

A WUS/WUR capable WTRU may perform cell reselection, for example based on its main receiver RRM measurements. If the new cell is WUS capable and the WTRU does not detect a WUS signal, for example for more than an amount of time, the WTRU may initiate a procedure such as a cell update procedure in the new cell and/or send WTRU WUS/WUR information to or in the new cell.

A WTRU may transmit a WUS uplink-based signal that the gNB may detect and that may trigger a WUS in the downlink according to broadcasted rules in the cell's SIBs. An uplink WUS may be a sequence at the physical layer.

A cell or gNB may be capable to turn OFF or ON WUS operation at any time.

A WUS OFF operation may be realized by a specific WUS signal or a dedicated WUS sequence. A paging indication or message may be used to indicate WUS OFF. The paging indication or message may indicate to a WTRU to read an updated SI. The cell or gNB may remove the SIB based WUS configurations or indicate them as inactive. When the WTRU determines the WUS is OFF (e.g. based on reading the new broadcasted SI), the WTRU may return to normal DRX operation based on the main receiver.

A WUS ON operation may additionally or alternatively be done through paging, which may indicate directly (e.g. as part of a paging message) or indirectly (e.g. indicating a WTRU to read an updated SI), as the gNB may turn ON the WUS configuration. When the WTRU determines that the WUS is ON (e.g. based on reading the SI), the WUS capable WTRU may turn on the WUR and follow the WUS operation indicated by the gNB. An ON/OFF indication may be via a direct indication in the paging DCI. When an ON/OFF indication is via a direct indication in the paging DCI, the WTRU may not or may not need to receive an SI to determine the ON/OFF state. The WTRU may determine the WUS state from the direct indication.

The WUS coverage threshold may be higher than a typical SSB minimum RSRP threshold as the WUS coverage may be smaller than that of the cell main signal. In this situation, upon losing the WUS coverage, the WTRU may send an indication to the network that is out of WUS coverage, for example using one of the examples or embodiments described herein that includes transmission of WUS coverage information.

When the WTRU determines that the WUS is out of coverage or after sending the out of coverage information, the WTRU may use or return to normal DRX operation using the main receiver.

A “WUS out of coverage” state may have its own WUS measurement timers and measurement threshold triggers or may use a SSB RSRP.

In an embodiment, the WUS coverage threshold may be a SSB RSRP based threshold. In this example, the WTRU may determine that the WUS signal is lost or out of coverage when the WTRU determines the WUS signal strength is below a threshold for a certain period of time, or the WUS signal is undetected for a certain number of consecutive WUS occasions. The WUS coverage may be determined by comparing the measurements of the main cell signal, performed by the main receiver while active according to the second DRX cycle, to a threshold corresponding to the WUS coverage.

After measuring cell SSB based RSRP and determining that the measurement results are less than a threshold that corresponds to a signaled WUS out of coverage, the WTRU may send a WUS out of coverage indication and/or use or continue its normal DRX operation.

If a WTRU that was previously in a WUS coverage and re-enters the WUS coverage, after a certain amount of time that may be defined by a timer, for example an SI validity timer, it may have to read again the WUS related SI.

A WTRU may receive updated WUS related SI. If the WUS related cell enabled capabilities described in the SI changed and, for example, the newly enabled WUS cell capabilities are supported by the WTRU, the WTRU may send WTRU WUS/WUR information to the cell, for example to renegotiate the WUS operation with the gNB.

If the WUS related cell capabilities changed so that the new cell WUS capabilities are less that previously negotiated, the WTRU may adjust to the new reduced subset of WUS operation. The WTRU may or may not send WTRU WUS/WUR information to the cell.

If the WUS related cell capabilities are turned OFF (e.g. in the new SI acquisition), the WTRU may return to its DRX operation (e.g. regular DRX operation). The WTRU may turn off its WUR.

In an embodiment, a WTRU may report to the gNB state information regarding the wake-up signal and/or the wake-up receiver. The reporting may be performed periodically, in an aperiodic manner, or a semi-static manner. The report may be triggered by an explicit and/or implicit indication from the gNB. An explicit indication may be carried in at least one of a L1 signal (e.g. PDCCH), a MAC CE, or higher layer signaling (e.g. RRC signaling). These reports may be transmitted by the WTRU while the WTRU is in a connected mode. The corresponding measurements may be performed by the regular or main receiver and/or the WUR.

In an embodiment, a WTRU may be requested to transition to a state in which the WTRU may be expected to monitor the WUS (e.g. an RRC IDLE state and/or an RRC INACTIVE state). Before the WTRU transitions to the indicated state, it may report to the gNB cell state information of the WUS (e.g. WUS state information) or WTRU WUS/WUR information. The resources on which the report is transmitted may be allocated dynamically or they may be preconfigured.

A WTRU may be configured to report the WUS state information or WTRU WUS/WUR information periodically. The WTRU may be configured to report WUS state information or WTRU WUS/WUR information in an aperiodic or semi-static manner.

A WTRU may report or send WUS state information using one or more of the ways described herein for sending WTRU WUS/WUR information. The WTRU may send WUS state information using resources allocated via a dynamic grant or a configured grant that may be received from or configured by a cell or gNB. A cell may be a serving cell.

The WUS state information may be derived from at least one measurement of the WUS. The state information may include a measurement of the WUS signal strength and/or signal quality (e.g. RSRP and/or RSRQ). The state information may include whether a measurement of the WUS signal is above or below a threshold and/or a difference between the measurement and the threshold. The state information may include whether the coverage of the WUS is above or below a threshold and/or the difference between the measured coverage and the threshold. The state information may include whether the WUS is usable and/or will be used by the WTRU. The state information may include a preferred data rate of the WUS and/or the data rate of the WUS that will be monitored. The state information may include a preferred type of the WUS and/or the type of the WUS that will be monitored. Different WUS types may have different attributes, for example: payload size, synchronization signal length and/or type, coding rate, data rate, periodicity. The state information may include a preferred transmit beam for the WUS. The transmit beam may be indicated by indicating an RS (e.g. by indicating the index of the RS) that may be QCLed with the beam. The state information may include a preferred DRX cycle for the WUS. The state information may include whether the WTRU can detect and/or reliably detect the WUS.

A WTRU may be configured with resources (e.g. time/frequency resources) to use for performing measurements for a corresponding WUS state report. The resources to measure may be referred to as the WUS RS. The WUS RS may be a RS that is transmitted for the WUR. For example, a waveform of the WUS RS may be different than a waveform of the RS used by the regular or main receiver. For example, a WUS RS may use ON-OFF keying. The WUS RS may be received by both the WUR and the regular or main receiver. The WUS RS may be transmitted by the gNB or cell without an accompanying payload, or it may be transmitted together with data (e.g. part of all of the preamble and/or the synchronization signal may be used as the RS).

The time/frequency location(s) of the configured resources may not be exact time/frequency location(s) but may indicate a range of time/frequency resources in which the WTRU may or may be expected to monitor the WUS RS. The WUS RS may be a sequence (e.g. a synchronization sequence and/or a preamble). The WUS resource may be in a frequency region of a BWP. The term time/frequency may be used to represent time and/or frequency.

A WTRU may use the configuration, which may be based on the WTRU report or regardless of the configuration the WTRU may assume the reported attribute (e.g. data rate) will be used.

A gNB may provide an indication (e.g. activation command) to the WTRU. WTRU reporting may be triggered based on the activation command.

In an embodiment, a gNB or cell may indicate to the WTRU whether to turn off the main receiver and/or use the WUR in Idle and/or Inactive mode. The indication may be included as part of a release message or transmitted in another channel and/or message. For example, based on a WUS state information report, the gNB or cell may configure the WTRU with an activation or deactivation of the WUR (configuration of the WUR and activation/deactivation). Activation/deactivation may be included in a MAC CE.

In an embodiment, a WTRU may determine one of a set of at least one coverage state based on whether a signal is detectable or not for at least one signal. At least one such signal may be a wake-up signal. The WTRU may initiate some actions and/or stop some actions when determining a change of coverage state and operate according to certain procedures depending on the coverage state.

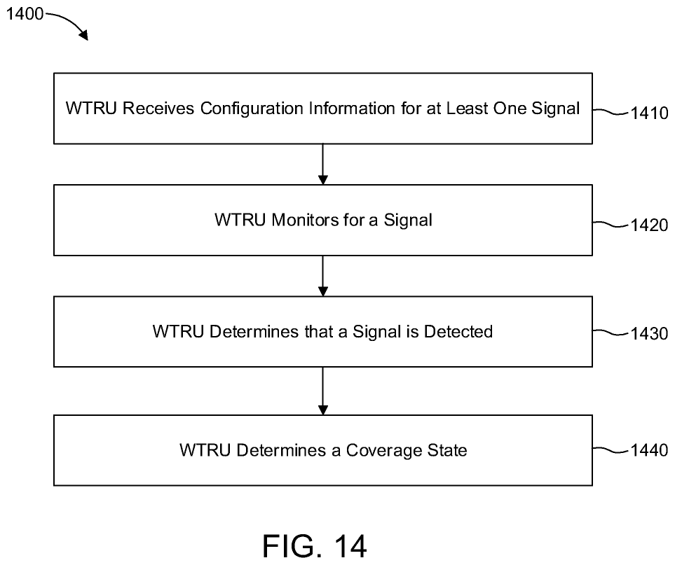

FIG. 14 shows an example method for determining a coverage state. A WTRU may receive configuration information regarding at least one signal (1410). The configuration information may be received in system information or in a dedicated RRC message such as an RRC connection release message The configuration information for each of the at least one signal may comprise at least one of the following properties: a time interval, or maximum or minimum thereof, between consecutive transmission occasions or periodicity; a number of repetitions for each time occasion; at least one sequence used for the generation of the signal such that each such sequence may be characterized by a type of sequence (e.g. Zadoff-Chu or Gold) and at least one parameter used for initializing the sequence; a data payload or size thereof; and a cyclic redundancy check (CRC) sequence or size thereof. The WTRU may be configured to monitor at least one signal (1420). The signal may be transmitted in multiple time occasions . . .

The WTRU may determine that a signal is detected in a time occasion (1430). The determination may be made if at least one of the following conditions is satisfied: the WTRU decodes a data payload with successful CRC in the time occasion; the WTRU measures a signal strength or quality (e.g. reference signal received power (RSRP), reference signal received quality (RSRQ), received signal strength indicator (RSSI), signal to interference noise ratio (SINR)) above a threshold in the time occasion. The WTRU may receive the value of a threshold by RRC signaling. Otherwise, the signal may be considered not detected in the time occasion.

A WTRU may determine that a signal is detectable at least for the purpose of coverage state determination. The signal may be detectable if the time elapsed since the signal was last detected in a time occasion is lower than a threshold. The signal may be detectable if the number of time occasions in which the signal was detected over a time window of a certain duration is higher than a threshold, or if at least the signal was detected in K out of the last N time occasions. Any threshold, duration, and/or counter (K, N) may be pre-defined or configured by RRC signaling.

A WTRU may be configured to monitor at least one type of signal. The WTRU may determine a coverage state (1440). Each signal may be associated (e.g. directly associated) to a coverage state that determines WTRU behavior for a certain functionality. The WTRU may determine that it is in-coverage for a coverage state if the associated signal is detectable, and out-of-coverage otherwise.

In an embodiment, a WTRU may receive a coverage rank associated to each signal as part of a configuration. The network may configure the coverage rank depending on a transmission power used for each type of signal, such that signals associated to lower coverage rank may be detectable at longer distances from the cell center. The WTRU may determine a coverage state based on the lowest coverage rank amongst the signal(s) that are not detectable. In case all signals are detectable, the WTRU may determine that it is in a maximum coverage state.

At least the following aspects may be a function of a coverage state and a WTRU may receive parameters related to these aspects for each coverage state from, for example RRC signaling: whether the WTRU performs RRM measurements on the serving cell and/or neighbor cells; the accuracy of RRM measurements; DRX configuration (e.g. for paging), including whether the WTRU uses a first or second DRX cycle; paging configuration, including whether PDCCH and/or PDSCH repetition is configured; search space; whether monitoring a paging occasion is conditional to the reception of a wake-up signal; whether the WTRU performs updates of positioning estimates or transmit/receive signals in support of positioning and the periodicity thereof.

In an example, the above aspects may enable a WTRU to determine estimation (e.g. crude estimation) of the serving cell quality based on a WUS, and therefore be used as a trigger to, for example, switch from a first DRX cycle to a second DRX cycle.

In an example, one WUS (e.g. WUS A) may be transmitted with a power corresponding to coverage at the cell center, and another WUS (e.g. WUS B) may be transmitted with a higher power, or with repetitions, to reach WTRUs at the cell edge. Whether or not the WTRU detects the WUS A may trigger the WTRU to use a shorter DRX cycle than currently used in order to increase the frequency of RRM measurements.

A WTRU may signal upon entering or exiting a coverage state. Upon change of coverage state from a first state to a second state, a WTRU may stop actions that are associated with the first state and start actions associated with the second state. The WTRU may further initiate transmission of a signal or notification to the network, Such signal or notification may be dependent on the first and/or second state or may indicate the first and/or second state. For example, the signal may be a PRACH, SRS, or other sequence. For example, the WTRU may initiate transmission of an RRC connection request with a specific cause (e.g. second state or a new RRC message). The message may also indicate detection statistics for at least one signal associated with a coverage state.

A WTRU may perform RRM measurements based on RRM measurement requirements,. The RRM measurement requirements may include one or more of following: absolute RSRP and/or RSRQ accuracy (e.g., SS RSRP, SSB RSRP, CSI-RS RSRP); and relative RSRP and/or RSRQ accuracy (e.g., SS RSRP, SSB RSRP, CSI-RS RSRP).

A WTRU may perform RRM measurements based on RRM measurement configuration. The RRM measurement configuration may include one or more of following parameters: measurement period; number of samples (e.g., OFDM symbols and/or slots) within a measurement period (e.g., SMTC window); measurement window length; number of cells for RRM measurement (e.g., neighboring cells for intra-frequency measurement); number of frequencies (or frequency layers) for inter-frequency measurement; and number of SSB beams.

A WTRU may determine the coverage of a WUS based on reception quality of a signal which may be sent from the cell sending the WUS. The signal may be at least one of: WUS, SSB, CSI-RS, TRS, and/or a signal which may be used to determine coverage of WUS. The signal which may be used to determine coverage of WUS may be a periodic signal transmitted periodically in a frequency in which WUS may be monitored or received by the WTRU. The signal which may be used to determine coverage of WUS may be interchangeably used with WUS, WUS-coverage reference signal (WC-RS), WUS-RS, and WUR-RS. The reception quality of the signal may be at least one of: RSRP, RSSI, RSRQ, and/or SINR.

A WTRU may determine that the WTRU is in-coverage of a WUS if one or more of following conditions are met: reception quality of a WUS-RS is higher than a threshold, or successful reception of a WUS (e.g., WUS received in a previous cycle). A WTRU may determine that the WTRU is out-of-coverage of a WUS if one or more of following conditions are met: reception quality of a WUS-RS is lower than a threshold, or N contiguous WUS reception failures, wherein N may be a predetermined value, configured by a network, or determined based on one or more conditions.

In an embodiment, one or more modes of operation for RRM measurement may be used. A WTRU may determine and/or perform a mode of operation for RRM measurement based on the coverage (e.g., coverage level) of a WUS.

A first mode of operation may be referred to as normal RRM measurement and a second mode of operation may be referred to as relaxed RRM measurement.

RRM requirements may be determined, used, or defined based on the mode of operation for RRM measurement. A first RRM requirements may be used for a first mode of operation and a second RRM requirements may be used for a second mode of operation. The second RRM requirements may be relaxed as compared with the first RRM requirements (e.g., higher accuracy or more frequent measurements may be required for a first mode of operation of RRM measurement than a second mode of operation of RRM measurement).

RRM measurement configuration may be determined, used, or configured based on the mode of operation for RRM measurement. A first RRM measurement configuration may be used for a first mode of operation and a second RRM measurement configuration may be used for a second mode of operation. One or more parameters for RRM measurement configuration for the second mode of operation may require less frequent RRM measurement by a WTRU including at least one of following. A measurement period may be longer in the second mode of operation. A number of samples within a measurement period may be smaller in the second mode of operation. A measurement window length may be longer in the second mode of operation. A number of cells for RRM measurement may be smaller for the second mode of operation. In an example, a subset of cells for the first mode of operation may be used, determined, or configured for the second mode of operation. In another example, a WTRU may perform neighbor cell measurements when the WTRU determines a first mode of operation while the WTRU may not perform neighbor cell measurements when the WTRU determines a second mode of operation. A number of frequencies or frequency layers for inter-frequency measurement may be smaller for the second mode of operation. In an example, a subset of frequencies for the first mode of operation may be used, determined, or configured for the second mode of operation. A number of SSB beams may be smaller for the second mode of operation. For example, a subset of beams for the first mode of operation may be used, determined, or configured for the second mode of operation.

A WTRU may perform the first mode of operation for RRM measurement if the WTRU is out-of-coverage of WUS, otherwise, the WTRU may perform the second mode of operation for RRM measurement.

A WTRU may perform the second mode of operation for RRM measurement if the WTRU is in-coverage of WUS, otherwise, the WTRU may perform the first mode of operation for RRM measurement.

In an embodiment, one or more modes of operation for RRM measurement may be used, wherein a WTRU may determine and/or perform a mode of operation for RRM measurement based on monitoring WUS type.

One or more WUS types may be used, wherein WUS type may be determined based on at least one of the following: a frequency band where the WUS signal may be monitored/received by a WTRU; WUS signal types (e.g., PDCCH, sequence, reference signal); bandwidth where the WUS signal may be monitored/received by a WTRU; and associated receiver type which may be used to monitor and/or receive WUS. In an example, a first receiver type may be a wake-up receiver which may be dedicated to monitor/receive WUS and a second receiver type may be a regular receiver which may be used to receive WUS as well as other types of signals (e.g., physical channels, reference signals, and others). In another example, a first receiver type may consume a first level of WTRU battery power and a second receiver type may consume a second level of WTRU battery power.

A WTRU may perform a first mode of operation for RRM measurement when the WTRU monitors a first WUS type, otherwise, the WTRU may perform a second mode of operation for RRM measurement.

In order to optimize deployment, an operator may configure WTRUs to report information related to the WTRU behavior so that the network may collect statistics regarding failures, cell coverage, etc. The WTRU may be configured to record a log in Idle mode which may include, for example cell measurements and location information. The WTRU may be required to report information regarding failures. It is expected that the WUS will require some self-organizing network (SON)/minimization of drive tests (MDT) information to be reported. The following information may be necessary to be reported by the WTRU, either as part of idle mode logging or as part of a radio link failure (RLF) report or other SON or MDT reporting messages.

When the WTRU responds to paging, it may indicate whether the WUS was used. This provides the network with crude statistical information regarding how often WTRUs in the system which are configured with a WUS respond to paging due to receiving WUS, and how many fallback to the regular operation.

The information reported may need to be enhanced as part of MDT logging or RLF reporting (e.g. WUS RLF) to provide the network with coverage and failure information in order to optimize the deployment. For example, information on the following may be recorded and reported to the network: timing information related to when the WTRU is successfully monitoring a WUS and when it switches to regular PDCCH monitoring; neighbor cell measurements and/or location information recorded upon switching on the main receiver due to a WUS (successful WUS and/or WUS failures); and WUS quality information, for example, signal quality, number of failures, and associated location and cell quality information if available.

A timer may count up until a specified time is reached. A timer may be set to a specified time and count down to a determined (e.g. zero) value. A timer may be implemented as a counter, clock, or any other method of defining a period of time. A timer may increment or decrement automatically or may be a periodic or an aperiodic comparison of a current time with a start time.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method, implemented by a wireless transmit/receive unit (WTRU), the method comprising:
receiving configuration information, wherein the configuration information comprises information regarding a first discontinuous reception (DRX) cycle with a first periodicity and a second DRX cycle with a second periodicity, wherein the configuration information comprises a time offset value (T), wherein the configuration information comprises a threshold value for wake-up signal (WUS) detection, and wherein the configuration information comprises a number (N) of monitoring occasions for missed WUS detections;
monitoring for a WUS according to the first periodicity;
monitoring for a paging indication according to the second periodicity;
on a condition that a WUS is not detected, monitoring for the paging indication according to the first periodicity, and receiving the paging indication; and
transmitting data over a physical random access channel (PRACH).

2. The method of claim 1, further comprising:
determining that the WUS is not detected by determining that a measurement of the WUS is less than the threshold value for WUS detection for N consecutive monitoring occasions.

3. The method of claim 2, further comprising monitoring for the paging indication according to the first periodicity after the time offset value (T) from a time of the Nth consecutive monitoring occasion.

4. The method of claim 1, wherein the second periodicity is longer than the first periodicity.

5. The method of claim 1, wherein the WUS signal is a low power WUS.

6. The method of claim 1, wherein the WTRU monitors for the WUS using a low power wake-up receiver (WUR).

7. The method of claim 1, wherein the WUS has a first waveform type, wherein the first waveform type is non-orthogonal frequency division multiplexing (non-OFDM).

8. The method of claim 1, wherein the paging indication is received via a second waveform type, wherein the second waveform type is orthogonal frequency division multiplexing (OFDM).

9. The method of claim 1, wherein the WTRU monitors for the paging indication using a main transceiver.

10. The method of claim 1, wherein the paging indication is received in a downlink control information (DCI) over a physical downlink control channel (PDCCH).

11. A wireless transmit/receive unit (WTRU) comprising:
a low power wake-up receiver (WUR); and
a main transceiver, wherein:
the main transceiver is configured to receive configuration information, wherein the configuration information comprises information regarding a first discontinuous reception (DRX) cycle with a first periodicity and a second DRX cycle with a second periodicity, wherein the configuration information comprises a time offset value (T), wherein the configuration information comprises a threshold value for wake-up signal (WUS) detection, and wherein the configuration information comprises a number (N) of monitoring occasions for missed WUS detections;
the WUR is configured to monitor for a WUS according to the first periodicity; the main transceiver is further configured to monitor for a paging indication according to the second periodicity;
the main transceiver is further configured to, on a condition that a WUS is not detected, monitor for the paging indication according to the first periodicity, and receive the paging indication; and
the main transceiver is further configured to transmit data over a physical random access channel (PRACH).

12. The WTRU of claim 11, further comprising a processor configured to determine that the WUS is not detected by determining that a measurement of the WUS is less than the threshold value for WUS detection for N consecutive monitoring occasions.

13. The WTRU of claim 12, wherein the main transceiver is further configured to monitor for the paging indication according to the first periodicity after the time offset value (T) from a time of the Nth consecutive monitoring occasion.

14. The WTRU of claim 11, wherein the second periodicity is longer than the first periodicity.

15. The WTRU of claim 11, wherein the WUS signal is a low power WUS.

16. The WTRU of claim 11, wherein the WUS has a first waveform type, wherein the first waveform type is non-orthogonal frequency division multiplexing (non-OFDM).

17. The WTRU of claim 11, wherein the paging indication is received via a second waveform type, wherein the second waveform type is orthogonal frequency division multiplexing (OFDM).

18. The WTRU of claim 11, wherein the paging indication is received in a downlink control information (DCI) over a physical downlink control channel (PDCCH).

19. The WTRU of claim 11, wherein the main transceiver is further configured to perform radio resource management measurements.

20. The WTRU of claim 11, wherein the main transceiver is configured to be in a sleep mode when the WUR is monitoring for the WUS.
